(19) United States
(12) Patent Application Publication
(10) Pub. No.: US 2010/0248682 A1
(43) Pub. Date: Sep. 30, 2010

(54) Method And Apparatus For Providing Visual/Audible Beacon To Assist In Locating An Emergency Caller

(75) Inventors: Perry Prozeniuk, Carleton Place (CA); Mark Fletcher, Ringwood, NJ (US); Conrad Uniacke, Kanata (CA); John Cato, Madoc (CA); Stephane Cliche, Orleans (CA)

Correspondence Address: Anderson Gorecki & Manaras, LLP;Attn: John C. Gorecki, P.O BOX 553, CARLISLE, MA, 01741, US

(73) Assignee: Avaya, Inc., Basking Ridge, NJ (US)

(21) Appl. No.: 12/749,211

(22) Filed: Mar. 29, 2010

Related U.S. Application Data
(60) Provisional application No. 61/164,251, filed on Mar. 27, 2009.

(51) Int. Cl. H04W 4/22

(52) U.S. Cl. 455/404.2

(57) ABSTRACT

A visual and/or audible beacon is provided by an access device or an external device to assist emergency response personnel to locate the person that initiated the emergency call. A communication server that handled the emergency call can cause lights on the access device to blink in a specified pattern, so that emergency personnel may more easily locate the access device that was used to place the emergency call. The communication server can also cause the access device to output a series of audible tones that may be used to locate the access device that was used to place the emergency call. Emergency response personnel may control the audible/visual beacon through the communication server to cause the beacon to be selectively activated or deactivated as necessary. Optionally the beacon may be turned off from the access device as well.

### CROSS-REFERENCE TO RELATED APPLICATIONS

This application claims priority to U.S. Provisional Patent Application No. 61/164,251, filed Mar. 27, 2009, entitled “Method and Apparatus for Providing Visual/Audible Beacon to Assist in Locating an Emergency Caller,” the content of each of which is hereby incorporated herein by reference.

### BACKGROUND OF THE INVENTION

1. Field of the Invention

The present invention relates to provision of emergency services and, more particularly, to a method and apparatus for providing a visual/audible beacon to assist in locating an emergency caller.

2. Description of the Related Art

Public emergency response services have been developed to enable citizens to contact emergency personnel in the event of an emergency. Such services are commonly used to summon police, fire, and ambulance services, although other emergency response teams may be summoned through the emergency services as well. Conventionally, a Public Safety Answering Point (PSAP) is established and made available to the public through a special dedicated telephone number. In the United States, it is common to use “911” to reach a local PSAP, although other numbers may be used to reach a PSAP in other jurisdictions. For example, in Australia, emergency services may be accessed by dialing “000,” while in several countries in Europe emergency services may be accessed by dialing “112,” “999,” “061,” “080,” “091,” 100,” or “101.” Thus a variety of numbers may be used to obtain access to the emergency response network.

When a person dials into an emergency response network by dialing 911 or another access number, it is important for the operator to be able to identify the location of the person making the phone call so that emergency personnel and equipment may be dispatched to the correct location. One way of doing this with traditional telephony equipment is through an Enhanced 911 (E911) service. E911 is an emergency telephone system capable of automatically displaying the callback number and in some cases the location of the person that dialed the emergency access number.

The North American emergency E911 phone system in many areas includes a voice network that is built largely outside of the normal Public Switched Telephone Network (PSTN) on which common voice traffic resides. Calls to emergency services are treated with higher importance and are routed differently from normal traffic within the PSTN. Essentially, calls to emergency services are routed on the basis of the calling number, not the called number. The calling number is checked against a database to determine the caller's location and determine which PSAP handles calls from the caller's location. When this information is determined, the call is then routed to the proper Public Safety Answering Point (PSAP).

In most E911 networks, the calling number and called number are transmitted in-band. This in-band signaling allows the calling number to be used to reference an Automatic Location Identification (ALI) database to find the caller's exact location and any other information about the caller that may have been stored in the database. It also provides the operator with a callback number in case the call is disconnected. However, the existing installed ALI systems were not designed to operate in an environment where telephony handsets are moving from location to location. Indeed, in many such systems it may take up to 24 hours to update a change in location in the ALI information database.

Cellular operators have developed another system so that the location of the cellular handset may be ascertained when a cellular handset is used to place a call to the PSAP. In the cellular context, there are various ways of ascertaining the location of a handset. Examples include using Global Positioning System (GPS) signals embedded in the transmission signal or using triangulation by looking to see which of the several Base Transceiver Stations (BTSs) in the neighborhood of the cellular handset are able to transmit/receive information from the cellular handset and, using direction and strength information, ascertaining a likely location of the handset.

A third type of telephony has recently been developed, which allows voice to be transmitted over a data communication network. Data communication networks may include various nodes, hubs, routers, switches, and other devices coupled to and configured to pass data to one another. These devices will be referred to herein as “network elements.” Data is communicated through the data communication network by passing protocol data units, such as frames, packets, cells, or segments, between the network elements by utilizing one or more communication links. A particular protocol data unit may be handled by multiple network elements and cross multiple communication links as it travels between its source and its destination over the network. Voice calls may be implemented on a data network using “Voice over IP” (VoIP). Typically, such calls are signaled using Session Initiation Protocol (SIP) although other protocols may be used as well.

Enabling voice traffic to be carried on a data network raises concerns with respect to the provision of emergency services. Specifically, since IP enabled handsets may connect to the network at any number of different points, it becomes difficult to ascertain the location of the person placing the emergency call to the PSAP. Additionally, where the IP network is supported by a wireless access network, e.g. a wireless access network implemented using one of the IEEE 802.11 family of standards, the location of the telephone on the network may change even more rapidly. Attempting to update these changes in the ALI database associated with the PSAP is simply not feasible, given the time it takes to update a change in the existing installed ALI databases.

One system has been proposed in which an Emergency Location ID Number (ELIN) is associated with each physical port on the network and uploaded to the ALI associated with the local PSAP. A database keeps track of IP handsets on the network and, upon receipt of an emergency call, associates an ELIN with the call and transmits the ELIN to the PSAP. The PSAP then uses the ELIN to key into the PSAP ALI database. Unfortunately, this solution presents a proprietary approach that will only work where the location information is able to be loaded into the ALI database. Moreover, since the ELIN information is static, this proposal does not support location of IP handsets in a wireless data network such as an 802.11x network.

All of these systems provide a general way to locate a person who placed the emergency telephone call. For example, if a telephone call is placed from a handset over an enterprise data network, the communication server that handled the call may know the approximate location of the person. The approximate location may be based on the port to which the access device was attached or the location of the wireless access point that was servicing the access device when the emergency call was placed. Where the call comes from an office building, for example, the call center may be able to direct emergency personnel to the correct floor and general area of the building. However, the emergency responders may be unfamiliar with the layout of the office space and, accordingly, may have a difficult time finding the person who placed the emergency call. Particularly where the office layout contains a labyrinth of cubicles interspersed with offices, it may be difficult to find the particular location of the access device that was used to place the emergency call. Since time is frequently of the essence when responding to an emergency call, it would be advantageous to provide a way to help the emergency personnel locate the access device that was used to initiate the emergency call.

### SUMMARY OF THE INVENTION

The following Summary and the Abstract set forth at the end of this application are provided herein to introduce some concepts discussed in the Detailed Description below. The Summary and Abstract sections are not comprehensive and are not intended to delineate the scope of protectable subject matter which is set forth by the claims presented below.

A visual and/or audible beacon is provided to assist emergency response personnel to locate the person that initiated the emergency call. The visual/audible beacon may be provided by the access device that was used by the person to place the emergency call, or may be provided by an external apparatus in the vicinity of the access device. In one embodiment, a communication server that handled the emergency call uses signaling to cause lights on the access device to blink in a specified pattern, so that emergency personnel may more easily locate the access device that was used to place the emergency call. In another embodiment, the communication server that handled the emergency call can cause the access device to output a series of audible tones that may be used to locate the access device that was used to place the emergency call. Emergency response personnel may control the audible/visual beacon through the communication server to cause the beacon to be selectively activated or deactivated as necessary. Optionally the beacon may be turned off from the access device as well.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of a communication network configured to implement an embodiment of the invention;

FIG. 2 is a perspective view of an example enterprise campus;

FIG. 3 is a signaling diagram showing the flow of information between an access device, communication server, PSAP, and emergency responder to enable a beacon to be used to help locate a person that initiated an emergency call according to an embodiment of the invention;

FIG. 4 is a diagram of an example access device that may be used in connection with an embodiment of the invention;

FIG. 5 is a flow diagram of an example process that may be used in connection with an embodiment of the invention;

FIG. 6 is a functional block diagram of an example communication server according to an embodiment of the invention; and

FIG. 7 is a functional block diagram of an example access device according to an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

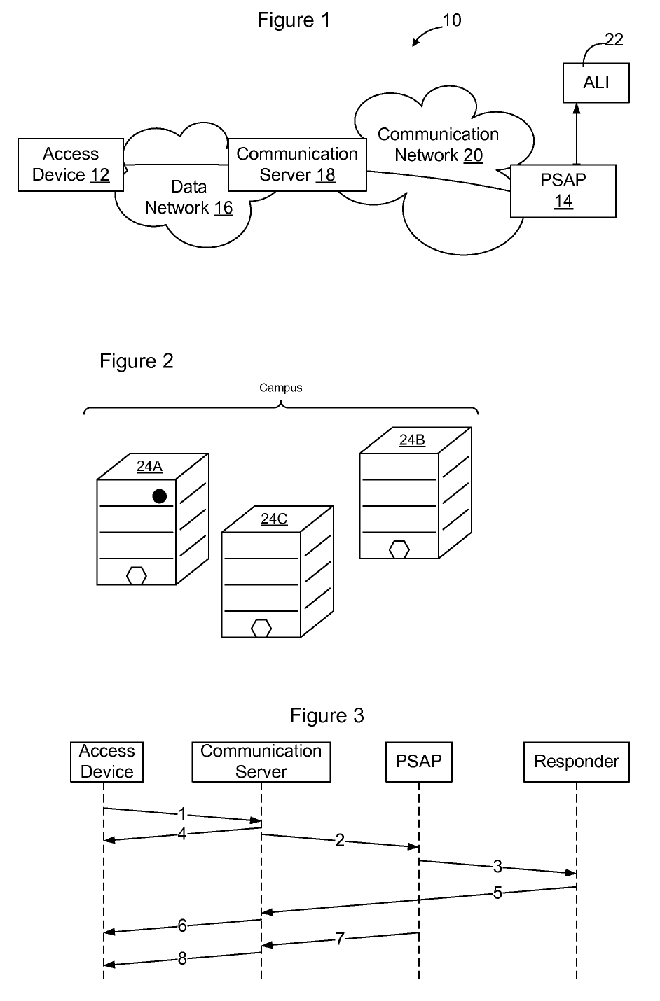

FIG. 1 illustrates a system 10 that may be used to summon emergency services. In the system shown in FIG. 1, an access device 12 connected to an enterprise data network 16 can cause a communication session 13 to be established with a Public Services Answering Point (PSAP) 14 to summon emergency services. A communication server 18 on the enterprise data network 16 is used to relay the call from the enterprise data network on to an external communication network 20. Alternatively, the communication server 18 may be hosted by a service provider on the communication network 20 rather than being deployed as part of the enterprise data network 16.

The enterprise data network may be implemented using a conventional networking technology such as Ethernet. The access device 12 may use SIP signaling on the enterprise data network to cause a voice over Internet Protocol (VoIP) session to be established between the communication server and the access device on the data network 16. Other ways of establishing voice or audio/visual session to be established on the enterprise data network may be used as well.

The communication server 18 establishes the emergency session with the PSAP 14 over the external communication network 20. The external communication network may be the Public Switched Telephone Network (PSTN), the Internet, or other communication network. The communication server 18 interfaces between the enterprise network and the external communication network to enable a communication session on the enterprise data network to be extended over the communication network 20 to the PSAP. The communication server may be a conventional communication server, Private Branch Exchange (PBX), gateway, or other network element configured to handle voice and other forms of communication sessions on behalf of the data network 16.

Once the call reaches the communication network 20, the call is handled like a regular emergency call according to the procedures established on that portion of the network. For example, optionally, where E-911 services are installed, an Automatic Location Identification (ALI) database 22 may be included to provide additional information associated with the emergency call to the PSAP operator.

As discussed in connection with FIG. 1, the emergency call itself is handled in a conventional manner to enable the call to be placed from the access device 12 to the PSAP 14. The PSAP will alert emergency personnel in a normal manner to enable the emergency personnel to respond to the emergency call. According to an embodiment, the emergency personnel may be assisted in locating the access device that was used to initiate the emergency session by causing lights on or associated with the access device to flash. Similarly, a speaker or other audio generator on or associated with the access device may be activated to provide an audible beacon to assist emergency personnel with locating the access device. Where devices other than the access device are used to help locate the access device, those devices may be dedicated to the access device or associated with more than one access device and located in the general area of the access device.

In operation, when an access device is used to initiate an emergency session, the communication server will establish a communication session with the access device on the data network 16 and will establish a communication session with the PSAP on communication network 20. When emergency personnel arrive on location, the communication server may be used to activate one or more beacons to help guide the emergency personnel to the location where the session was initiated to help find the access device and, hence, accelerate provision of emergency assistance.

FIG. 2 shows an example enterprise campus, including three buildings 24A, 24B, 24C. Each of the buildings has several floors and a main entrance. When emergency personnel arrive at the campus, they will need to be directed to the correct building, the correct floor of the building, and the correct location on the floor. For example, the dot on the top floor of building 24A marks a hypothetical location of an access device that may be used to initiate an emergency session. The communication server may be able to instruct the emergency personnel to the correct building and, possibly the correct floor and location within the floor. This may be done using conventional location systems which allow the location of a communication session (e.g. access port or wireless access point) to be located and correlated with a physical location. However, the emergency personnel may not be familiar with the layout of the building and therefore may be delayed in responding to the emergency.

According to an embodiment, the access device may be activated automatically or on command when emergency personnel arrive at the enterprise campus to enable the emergency personnel to more quickly locate the access device. For example, as is known in the art, a fire panel or other access panel in the building lobby may be used to interface with the communication server. Activating the notification feature of the access device upon arrival of the emergency personnel at the building also provides the person who initiated the emergency session with advance notification that the emergency personnel have arrived on campus and are in the process of locating the person.

Emergency responders may cause the audible or visual alert to be initiated by interacting with the communication server directly or, alternatively, by interacting with an enterprise employee who can interact with the communication server. For example, it is common for large buildings to have a guard stationed at the entrance. The guard may access the communication server via a telephone or via a web page to cause the access device to initiate an alert sequence. Other ways of accessing the communication server may be used as well depending on how the communication server is implemented. For example, where the communication server is implemented by a service provider, the communication server may be accessed via a vertical service code, e.g. *XX. Likewise, the PSAP operator may interact with the communication server to activate the beacon feature of the access device. Other ways of accessing the communication server may be implemented as well.

FIG. 3 shows a signaling flow diagram of an example process that may be utilized to cause an access to provide a visual and/or audible beacon to help emergency personnel locate access device upon arrival. As shown in FIG. 1, when the person initiates an emergency communication session from the access device (arrow 1) the emergency call will be received at the communication server and forwarded to the PSAP (arrow 2). This portion of the process is well known in the art and there are many ways of establishing a voice-based or audio-visual based communication session. The PSAP will notify emergency responders (arrow 3) so that the emergency responders may provide assistance to the person who initiated the emergency communication session.

According to an embodiment, the communication server will maintain information about the communication session, at least within the portion of the emergency communication session that occurred within the enterprise data network, so that the communication server can later interact with the access device that was used to initiate the emergency communication session to cause the access device to activate an emergency alert sequence such as to cause the access device to flash its available lights and/or make sounds.

The phone may automatically initiate the beacon sequence on its own or the communication server may instruct the access device to initiate an emergency alert sequence (arrow 4). This may happen directly after the call is placed by the user or at a desired interval thereafter. Likewise, the responder may interact with the communication server (directly or through an employee) (arrow 5) to cause the communication server to interact with the access device (arrow 6) to initiate the emergency alert sequence. Likewise the PSAP may interact with the communication server (arrow 7) to cause the communication server to interact with the access device (arrow 8) to initiate the emergency alert sequence. Assuming that the person who initiated the emergency session is proximate the access device, this will accelerate the rate with which the emergency responders are able to provide assistance to the person in need. Likewise, the communication server may be accessed by the emergency personnel to intensify the beacon, for example if there is considerable noise in the area the communication server may be used to increase the volume of the emergency beacon.

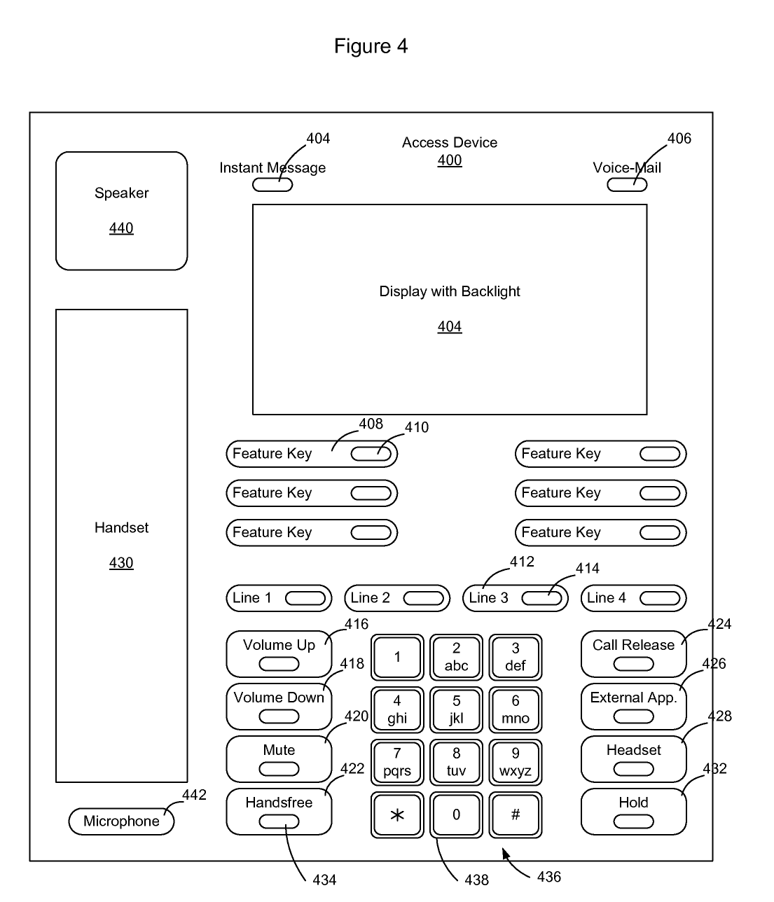

FIG. 4 shows an example access device that may be connected to an enterprise network. Specifically, the example shown in FIG. 4 is a desktop telephone configured to initiate and terminate calls made using Voice over IP. Commonly, access devices of this nature are referred to as IP phones because the phones are designed to connect to a data network and communicate using the Internet Protocol (IP). Other types of access devices may be used as well, however for purposes of explaining an embodiment of the invention, the particular access device shown in FIG. 4 will be described in greater detail.

In the example shown in FIG. 4, the access device 400 has many buttons that may be used to access particular features. For example, the access device has a display 402 that may be used to show information about established communication sessions. Commonly, the display would have a plurality of LEDs or other light sources providing a backlight to the display so that users can see information appearing on the display. Optionally, the backlight may be turned on/off as part of the alerting sequence.

The access device 400 also has a plurality of LEDs 404, 406 that provide the user with information about pending messages. For example, in the illustrated embodiment the access device includes a LED 404 which is illuminated to show the user when the user has pending instant messages and another LED 406 that may be used to show the user when there are pending voice-mail messages. Other LEDs may be used as well to provide other types of information to the user.

The access device also includes a plurality of buttons, at least some of which may include LEDs to indicate to the user when particular features are activated. The access device shown in FIG. 4 has six feature keys 408 that may be programmed by the user to provide particular features. Each of the feature keys may have an LED 410. The access device in FIG. 4 also has four line keys 412 which may be pressed to select different lines on which the user may communicate. On an enterprise network, each “line” would be associated with a different IP address so that the user could establish up to four separate communication sessions. To select a communication session, the user would press one of the line buttons causing the LED 414 associated with that line to become illuminated.

The access device shown in FIG. 4 also has a number of buttons that may be used to control operation of the access device during a particular communication session. For example, the access device has volume up/down keys 416, 418, a mute button 420, a handsfree (speaker phone) button 422, a call release button 424, an external application button 426 that may allow a user to add a particular service to the call from an external application, a headset button 428 allowing the user to hear the call through a headset rather than through a handset 430, and a hold button 432. Each of these buttons in the illustrated example includes an LED 434 to provide visual feedback to the user when a particular feature has been selected. Different access devices may have different selections of features that are available to the user via dedicated buttons on the access device, and not all of these buttons is required to include a LED 434.

The access device in the example shown in FIG. 4 further includes a keypad 436 having a standard 12 key dialing pad. The keypad 436 in the illustrated example has a backlight which shows around and optionally through each of the keys to make it easier to dial numbers when it is necessary to use the access device in the dark.

All of the LEDs on the access device, including the LEDs or other devices providing backlight for the display, the dedicated LEDs 404, 406, the status indicator LEDs 410, 414, 434, and the LEDs 438 that provide backlighting to the keypad have functions on the access device. For example, as described above, commonly these LEDs are used to provide status information to the user about particular features of the Access Device. According to an embodiment of the invention, all or a large number of these LEDs may be turned on and off in an alternating pattern to provide a visual beacon to help emergency personnel locate the access device that was used to initiate the emergency communication session. Specifically, in response to detection of placement of an emergency call the available lights of the access device may be activated automatically or on command to enable the access device to provide a visual beacon to help emergency personnel locate the access device when responding to the emergency call.

If the environment is unlit, flashing a large number of LEDs should be visible, even if the individual LEDs are not very bright. Likewise, depending on the power of each of the LEDs, flashing a large number of LEDs may be visible even if the office environment is lit. For example, the access device shown in FIG. 4 has 20 LEDs plus the display and keypad backlights that may be activated. If all of these LEDs and other lights on the access device are illuminated at once, it is likely that the additional colored light would be visible (e.g. via reflection off a ceiling/walls) even if the environment is relatively brightly lit. The lights may flash all the same color, different colors, or may be caused to alternate colors depending on the embodiment.

The access device shown in FIG. 4 also has a speaker 440 and a microphone 442. The speaker 440 may be used to output an audible beacon signal which may be streamed to the access device over the established communication session or may be generated by the access device. Optionally, input from the user may be obtained via the microphone and output in louder form via the speaker 440. Other ways of generating audio to be output by the speaker 440 may be implemented as well.

Numerous different alert sequences may be used to help emergency personnel locate the access device. For example, the communication server may cause the lights on the access device to start blinking and/or may cause an audible alert tone to be generated by the access device. Preferably the audible alert tone may be distinguishable from a normal ring tone or other similar tone commonly generated by handsets. Thus, in one embodiment, the access device may repeatedly emit a series of three short loud tones followed by a brief period of silence. Other embodiments may use other specific alerting tones and the invention is not limited to this particular embodiment. Similarly, blue and red lights on the handset may be caused to blink on/off in a particular pattern to enable the access device to attract attention. Other lights on the access device or attached to the access device may be caused to blink as well.

The access device may also be associated with one or more external audible/visual systems such that may be used to help locate the access device. For example, when the building in which the access device is located has a fire alarm system, the fire alarm system strobe lights in the area may be activated to draw attention to the area of the building where the access device is located. Similarly, a light on the front of the building where the person is located may be caused to flash on/off to help the responding personnel locate the correct building. In a residential application, a wireless switch associated with front walkway lights may be activated over the wireless enterprise network deployed within the residence to cause the front walkway lights to turn on/off to help emergency personnel locate the correct house. Other systems may be used as well and these are simply several examples of ways that external beacons may be coordinated over the enterprise network in connection with receipt of an emergency call.

Similarly, if one or more external devices is attached to the access device then the external devices may be activated to provide the beacon. For example, the device may include a USB port and the person may have an external speaker attached to the access device via the USB. Likewise, if the person has a medical condition or otherwise is likely to need emergency assistance, the person may have an external light beacon attached to the access device USB port. Such external device may be activated in addition to or instead of the available lights and speakers that form part of the access device.

Many different types of access devices may be used in connection with embodiments of the invention. For example, where the access device is an IP phone having a LCD screen and speaker phone capabilities, the LCD screen may be caused to flash and audio may be generated and output by the speaker phone. Where the access device is a soft client on a computer, the computer screen may be caused to flash on/off to provide a visual indication that the computer was used to generate the emergency call. Many different options are available.

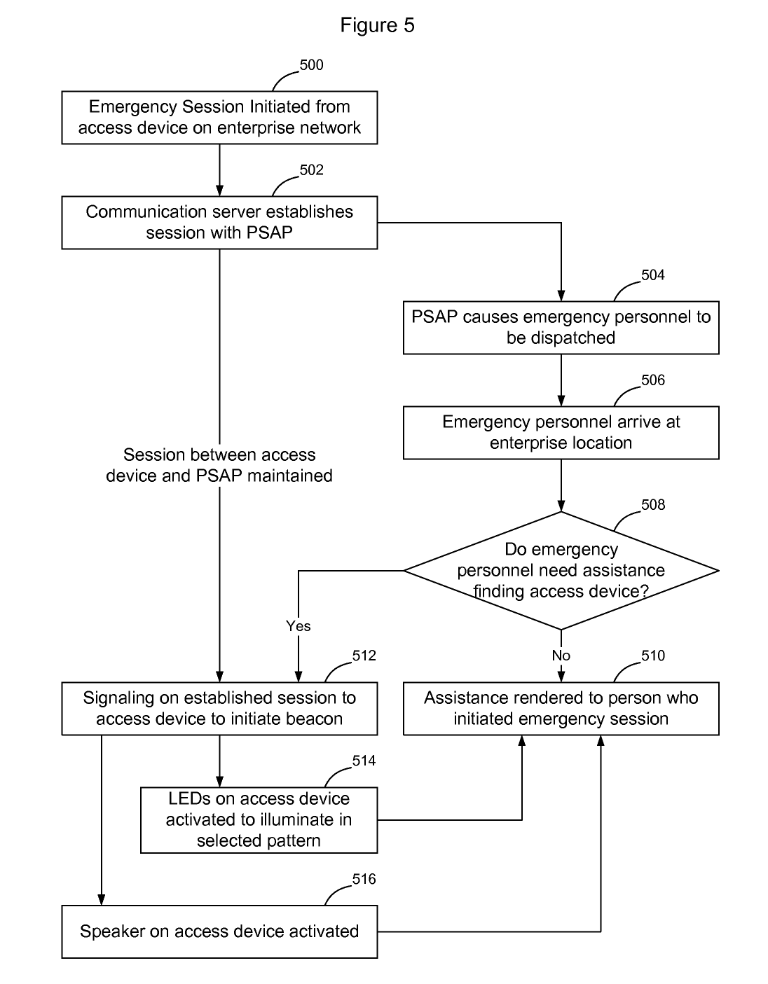

FIG. 5 shows an example process that may be used to implement an embodiment. In FIG. 5, it will be assumed that an emergency communication session has been established over an enterprise network from an access device communicating via the enterprise network (500). When the communication server receives a request for an emergency session, it will interact with the external communication network to establish a communication session with the PSAP (502).

The operator at the PSAP will interact with the person who initiated the emergency communication session and, if necessary, will cause emergency personnel to be dispatched (504). In the illustrated example, the call was routed through to a PSAP. The invention is not limited in this manner, however, as particular enterprises such as college campuses may have their own emergency response system. For example, a college may have campus police and an Emergency Medical Response team that is dedicated to providing support on the college campus. If an emergency communication session is initiated on the college's enterprise data network, the communication session may be routed to the campus based emergency services center rather that to a public PSAP. However for purposes of this example, it will be assumed that the call is routed to a public PSAP.

After being dispatched, the emergency personnel will arrive the enterprise location (506) and attempt to locate the person who initiated the emergency communication session. The emergency personnel will evaluate whether they need assistance finding the person who initiated the communication session and, if so, whether it would be helpful to try to find the access device that was used to initiate the emergency communication session (508). If activation of the beacon is not necessary, and the emergency personnel find the person, they will administer assistance in a normal manner (510).

If assistance is required, then the communication server will be accessed to instruct the communication server to initiate the alert sequence via the access device (512). Specifically, the emergency personnel or someone associated with the enterprise network may use signaling on the established session with the access device to initiate a beacon (514) to cause the lights on the access device to flash (514) and/or to cause audible tones to be generated and output from the access device (516).

In operation, a security guard at the facility may have an access panel that may be used to interface with the communication server to activate/deactivate the beacon. Similarly, the security guard may have a computer terminal with a browser or other window through which the security guard may access a user interface to the communication server. When emergency personnel arrive at the building where the emergency call was placed, the emergency personnel will typically interface with the on-site security personnel to determine where they are required to go to locate the person who placed the emergency call. The security guard, in one embodiment may be provided with the ability to interface with the communication server to activate/deactivate the beacon. Likewise, the emergency personnel may be provided with access to the communication server in the form of a telephone number/password to enable them to activate or deactivate the beacon directly. Still alternatively, the PSAP may instruct the communication server to activate the beacon.

Once the emergency personnel have located the person who placed the emergency call, the beacon will likely no longer be necessary. Accordingly, in one embodiment, the beacon may be turned off at the access device by pressing a button or combination of buttons on the access device. Optionally a security code may be required to turn the beacon off to prevent a nefarious person from interfering with the beacon once activated. Many ways of turning the beacon off may be implemented. The communication server may also be accessed by the security guard, emergency responder, or PSAP to cause the beacon to be deactivated in a manner similar to how the beacon was activated.

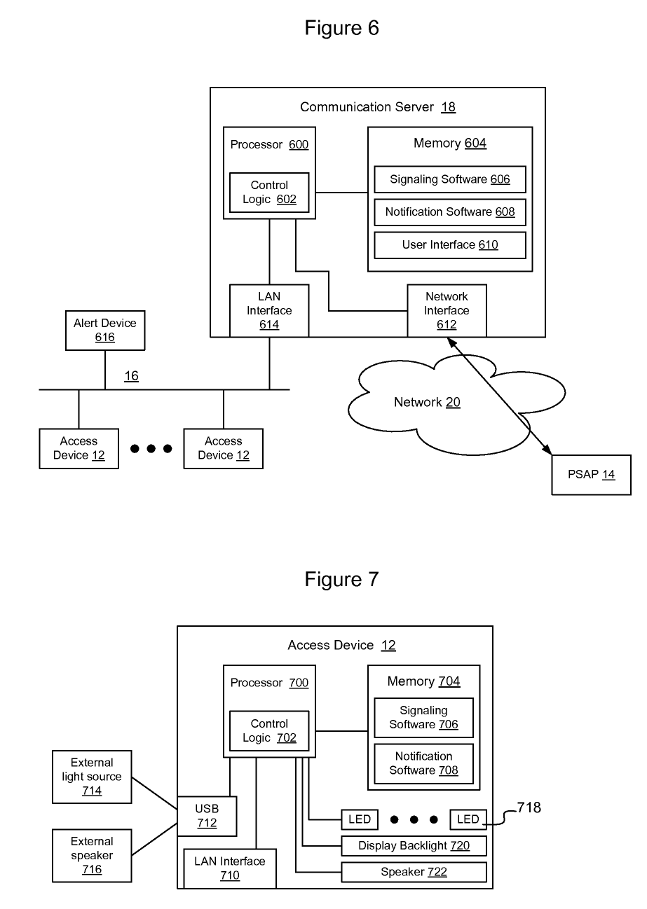

FIG. 6 shows an example of a communication server 18 that may be configured to implement an embodiment of the invention. In the embodiment illustrated in FIG. 6, the communication server includes a processor 600 having control logic 602 configured to enable the communication server to perform functions ascribed to it herein. The communication server 18 includes a memory 604 in which signaling software 606, notification software 608, and user interface software 610 are stored. These software components may be integrated into one software package or may be separate software modules. The communication server also includes a network interface 612 over which the communication server is able to interface with the PSAP, and a LAN interface 614 over which the communication server is able to interface with the enterprise data network. Access devices 12 and optionally external alert device 616 communicate with each other and the communication server on enterprise data network 16.

In operation, signaling software 606 stored in memory 604 will be loaded into processor 600 as control logic 602 to enable the communication server 18 to establish communication sessions with the access device. Notification software 608, which may be part of the signaling software or a separate software module, is used to control activation of the alerting features of the access device. The signaling software and notification software use the established communication session to control initiation of the alerting feature of the access device.

The alert generated by the access device may be generated locally on the access device. For example, the access device may have an alert feature coded into the software image stored on the access device to enable it to generate the alert when instructed to do so. In this embodiment, the communication server would use signaling to cause the access device to initiate and terminate stop the alert process. Alternatively, the alert generated by the access device may be generated at the communication server and streamed to the access device. For example, the communication server may instruct the access device to turn on all LEDs and then instruct the access device to turn off all LEDs. Other signals may be used to directly control the visible aspects of the display of the access device as well. Similarly, an audio stream to be output by the access device may be streamed to the access device by the communication server.

User interface software 610 enables the person who initiated the emergency communication session, a security guard, emergency personnel, or other individuals to activate and deactivate the alert features of the access device.

Where an external device 616 is used to generate an alert beacon, the communication server 18 will determine the approximate location of the access device, determine the closest one or small set of alert devices, 616, and then activate the alert devices via network 16. The notification software may be configured to perform this process, alone or in combination with presence software (not shown). Other software modules may be included as well and the example illustrated in FIG. 6 shows one example of a set of software components that may work together to implement an emergency alert system according to an embodiment.

FIG. 7 shows an example of an access device 12 that may be configured to implement an embodiment of the invention. In the embodiment illustrated in FIG. 7, the access device includes a processor 700 having control logic 702 configured to enable the access device to perform functions ascribed to it herein. The access device 12 includes a memory 704 in which signaling software 706 and notification software 708 are stored. These software components may be integrated into one software package or may be separate software modules. The access device also includes a LAN interface 710 over which the communication server is able to interface with the enterprise data network. One or more additional interfaces, such as a Universal Serial Bus port 712 may also be provided to connect the access device 12 to an external light source 714 and/or an external audio generator (speaker) 716.

As noted above in connection with FIG. 4, the access device 12 has a plurality of LEDs 718 that are used to provide status indications of particular features of the access device. The access device also includes a display with a backlight 720 and a speaker 722. In operation, the notification software 708 is loaded as control logic into processor 700 to enable the LEDs 718 to be activated in response to initiation of an emergency call or in response to signaling received in connection with an emergency call. Optionally, notification software 708 may cause all of the LEDs to be illuminated. Illumination of the LEDs under the control of the notification software 708 causes selected LEDs to be illuminated without reference to the underlying function normally associated with the LEDs, so that the LEDs may be used to provide a visible beacon in connection with an emergency communication session.

The control logic may be implemented as a set of program instructions that are stored in computer readable memory within the network element and executed on a microprocessor within the network element. However, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, or any other device including any combination thereof. Programmable logic can be fixed temporarily or permanently in a tangible medium such as a read-only memory chip, a computer memory, a disk, or other storage medium. All such embodiments are intended to fall within the scope of the present invention.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A method of providing a visual and/or audible beacon in connection with placement of an emergency call on an emergency response network, the method comprising the steps of:
receiving information relating to initiation of an emergency communication session from an access device; and
signaling a device to generate at least one of a visual beacon and audible beacon in the vicinity of the access device to help emergency personnel responding to the emergency communication session to locate the access device.

2. The method of claim 1, wherein the step of signaling the device comprises signaling the access device.

3. The method of claim 2, wherein the access device has a plurality of status indication Light Emitting Diodes (LEDs) and wherein the step of signaling the access device causes the LEDs to be illuminated irrespective of a status associated with the LEDs.

4. The method of claim 3, wherein the step of signaling the device causes all of the LEDs to turn on and off in a repetitive pattern.

5. The method of claim 2, wherein the signaling occurs on the emergency communication session.

6. An access device, comprising:
a display, a keypad, and a plurality of Light Emitting Diodes (LEDs), each of the LEDs being configured to provide a user with information about status of features of the access device; and
a processor containing control logic configured to cause the LEDs to be activated to form a visual beacon upon establishment of an emergency communication session.

7. The access device of claim 6, wherein the control logic causes the LEDs to be illuminated regardless of the status of the features of the access device to cause the access device to generate light to help emergency response personnel locate the access device.

8. The access device of claim 6, wherein the access device further comprises a backlight associated with the display, and wherein the processor further contains control logic to cause the backlight to be turned on and off in a repetitive pattern upon establishment of the emergency session.

9. The access device of claim 6, wherein the control logic causes all of the LEDs to be activated automatically upon establishment of the emergency communication session.

10. The access device of claim 6, wherein the control logic causes a majority of the LEDs to be activated automatically upon establishment of the emergency communication session.

11. The access device of claim 6, wherein the control logic causes the LEDs to be activated at a predetermined time after establishment of the emergency communication session.

12. The access device of claim 6, wherein the control logic causes the LEDs to be activated upon receipt of an instruction from a communication server after initiation of an emergency communication session by the access device.

13. The access device of claim 12, wherein the access device is no longer active on the emergency communication session at the time of receipt of the instruction from the communication server.

14. The access device of claim 12, wherein the access device is active on the emergency communication session at the time of receipt of the instruction from the communication server.

15. A computer readable medium containing data and instructions which, when loaded as control logic into one or more processors of a communication server, causes the communication server to perform a method comprising the steps of:
establishing emergency communication sessions on an enterprise network with an access device;
receiving instructions to activate a beacon function on the access device to help locate the access device; and
instructing the access device to activate a beacon function.

16. The computer readable medium of claim 15, wherein the step of instructing the access device comprises the step of signaling the access device in connection with the emergency communication session.

17. The computer readable medium of claim 15, wherein the beacon function is implemented by the access device by causing a plurality of lights on the access device to be illuminated.

18. The computer readable medium of claim 15, wherein the beacon function is implemented by causing a majority of the lights on the access device to turn on and off in a repetitive pattern.

19. The computer readable medium of claim 15, wherein the beacon function is implemented by the access device by causing a speaker on the access device to be activated to output an audible signal.

20. The computer readable medium of claim 15, wherein the step of receiving instructions comprises receiving instructions from a Public Service Answering Point to activate the beacon function on the access device.
